(19) United States
(12) Patent Application Publication
(10) Pub. No.: US 2023/0405558 A1
(43) Pub. Date: Dec. 21, 2023

(54) SHEET NIOBATES FOR USE IN PHOTOCATALYSTS

(71) Applicant: TANIOBIS GMBH, GOSLAR (DE)

(72) Inventors: CHRISTOPH SCHNITTER, HOLLE (DE); SVEN ALBRECHT, GOSLAR (DE); ROLAND MARSCHALL, BAYREUTH (DE); NATALIA KULISCHOW, NEURUPPIN (DE); FLAVIU CALIN LADASIU CIOLACU, SEAFORD MEADOWS (AU)

(73) Assignee: TANIOBIS GMBH, GOSLAR (DE)

(21) Appl. No.: 18/038,214

(22) PCT Filed: Nov. 10, 2021
(86) PCT No.: PCT/EP2021/081245

§ 371 Date: May 23, 2023

(30) Foreign Application Priority Data
Nov. 27, 2020 (DE) 10 2020 214 923.2

(51) Int. Cl. B01J 23/20; B01J 35/00; C01B 3/04; C01G 33/00; B01J 23/648

(52) U.S. Cl. CPC B01J 23/20; B01J 35/004; C01B 3/042; C01G 33/006; B01J 23/6484; C01P 2002/20; C01P 2002/72

(57) ABSTRACT

A layered niobate which is used as a photocatalyst. The layered niobate has the formula [HₐA_{b}]⁺[Sr₂Nb₃O₁₀]⁻. [Sr₂Nb₃O₁₀]⁻ forms main layers. [HₐA_{b}]⁺ forms interlayers, wherein H includes H⁺ and H₃O⁺, A is K⁺, Cs⁺ and Rb⁺, 0.6≤a≤1, 0≤b≤0.4, and a+b=1. The layered niobate has different spacings between the main layers.

### CROSS REFERENCE TO PRIOR APPLICATIONS

This application is a U.S. National Phase application under 35 U.S.C. § 371 of International Application No. PCT/EP2021/081245, filed on Nov. 10, 2021 and which claims benefit to German Patent Application No. 10 2020 214 923.2, filed on Nov. 27, 2020. The International Application was published in German on Jun. 2, 2022 as WO 2022/112002 A1 under PCT Article 21(2).

### FIELD

The present invention relates to layered niobates of the formula HaAbSr₂Nb₃O₁₀, where H is a group comprising the elements H⁺ and H₃O⁺, and A is an element of the group of K⁺, Cs⁺ and Rb⁺, where 0.6≤a≤1 and 0≤b≤0.4, where a+b=1, which are notable in that they have different layer spacings, to a process for the production thereof, and to the use thereof in photocatalysts.

### BACKGROUND

In photosynthesis, sunlight is converted into chemical energy, with sugar being formed from carbon dioxide and water and being stored in plants in the form of cellulose, with the original energy being reusable by combustion of the plants. The storage of solar energy in the form of hydrogen is based on a similar principle. Water can be split into hydrogen and oxygen by sunlight in the presence of a catalyst. If the hydrogen is combusted again, it releases energy and water and can therefore be used, for example, as an alternative energy source. This form of energy generation is advantageous in that, unlike, for example, when combusting wood or other fossil raw materials, no environmentally damaging byproducts are formed and, in contrast to wind or solar energy, it is independent of the time of day and weather conditions. Compared to conventional water electrolysis, photocatalytic splitting of water also has the advantages of moderate reaction conditions and relatively low technical requirements.

The first photocatalysts based on titanium dioxide were presented as early as the 1970s, but it was not possible to increase the efficiency of this process so that hydrogen could be produced in large amounts. One class of compounds considered to be promising in this regard are layered perovskites of the Dion-Jacobson type of the general formula:

MAₙ₋₁BₙO₃ₙ₊₁,

where M is an alkali metal, A is an alkaline earth metal or rare earth metal, and B is a pentavalent metal, generally tantalum or niobium, these compounds being referred to as layered niobates in the case of niobium. These compounds are constructed from negatively charged perovskite main layers of the general formula [Aₙ₋₁(BₙO₃ₙ₊₁)]⁻, between which the alkali metal ions are intercalated as positive interlayers. These compounds can easily be modified by ion exchange due to their layer structure and the relatively large spacing between the layers. For example, in the interlayers, the alkali metal ions can be replaced by protons and water molecules, whereby the photocatalytic activity, i.e., the amount of hydrogen produced when irradiated with light, of such compounds can be increased.

Extensive studies relating to layered perovskites and their activity with regard to photocatalytic evolution of hydrogen have been published in the literature.

Domen et al., in their article “Ion exchangeable layered niobates as a noble series of photocatalysts”, published 1994 in Res. Chem. Intermed., Vol. 20, No. 9, pages 895 to 908, studied the dependency of the layer spacing and the evolution of hydrogen for KCa₂Nb₃O₁₀. It was described that the layer spacing increased gradually with an increasing degree of protonation, the gradual increase in the layer spacing being attributed to the different degrees of hydration, i.e., the incorporation of water molecules together with the protons in the interlayers. A significant increase in the rate of hydrogen formation was observed from a degree of exchange of 60%, which was explained by the fact that with large layer spacings, methanol molecules get into the interlayers and there act as electron hole scavengers. The authors assume that this makes it possible for the recombination rate between electrons and electron holes to be reduced, so that more electrons are available for the reduction of water molecules to form hydrogen.

Huang et al., in the article “Photocatalytic property of partially substituted Pt-intercalated layered perovskite, ASr₂TaₓNb₃₋ₓO₁₀ (A=K, H; x=0, 1, 1.5, 2 and 3)”, published in Solar Energy Materials & Solar Cells 95, (2011) 1019-1027, describe XRD spectra and hydrogen formation rates, for example, for HSr₂(Ta/Nb)₃O₁₀. A layer spacing of 15.04 Å is stated for this compound, which after reaction with acid to form HSr₂Nb₃O₁₀, was 16.53 Å. The evolution of hydrogen from 10% methanol solution under irradiation with a mercury vapor lamp displayed higher values for the protonated compound HSr₂Nb₃O₁₀ than for the standard photocatalyst TiO₂ P25.

The publication “Comparison of two- and three-layer restacked Dion-Jacobson phase niobate nanosheets as catalysts for photochemical hydrogen evolution” by Maeda et al. in J. Mater. Chem, 2009, 19, 4813-4818, described the production of layered niobate nanosheets by exfoliation of the corresponding Dion-Jacobson layered perovskites (HCa₂Nb₃O₁₀, HSr₂Nb₃O₁₀ and HLaNb₂O₇) with tetra(n-butyl)ammonium and subsequent treatment with hydrochloric acid, and the measurement of their photocatalytic properties and comparison with those of conventional compounds.

Fang et al., in the Journal of Wuhan University of Technology—Mater. Sci. Ed., 2002, Vol. 7, No. 2, under the title “Synthesis and characterization of a new triple-layered Perovskite KSr₂Nb₃O₁₀ and its protonated compounds”, describe the production of KSr₂Nb₃O₁₀ by solid-state synthesis, followed by a treatment with acid, in order to obtain the compound HSr₂Nb₃O₁₀*1.5H₂O by way of proton exchange. The layer spacings stated for the two compounds are 15.0 Å (KSr₂Nb₃O₁₀) and 16.4 Å (HSr₂Nb₃O₁₀*1.5H₂O).

### SUMMARY

An aspect of the present invention is to provide photocatalysts having improved efficiency which can be used for the solar-chemical splitting of water.

In an embodiment, the present invention provides a layered niobate having a formula [HₐA_{b}]⁺[Sr₂Nb₃O₁₀]⁻. [Sr₂Nb₃O₁₀]⁻ forms main layers. [HₐA_{b}]⁺ forms interlayers, wherein H comprises H⁺ and H₃O⁺, A is an element of the group consisting of K⁺, Cs⁺ and Rb⁺, 0.6≤a≤1, 0≤b≤0.4, and a+b=1. The layered niobate has different spacings between the main layers.

### BRIEF DESCRIPTION OF THE DRAWINGS

The present invention is described in greater detail below on the basis of embodiments and of the drawings in which:

FIG. 1 shows an XRD diagram of an inventive layered perovskite of the formula [HₐK_{b}]Sr₂Nb₃O₁₀ (A) with different degrees of protonation, where K⁺ was exchanged for H⁺, with (a) reference diagram for the 100% proton-exchanged, completely dry compound and (b) reference diagram for the 100% proton-exchanged, completely hydrated compound;

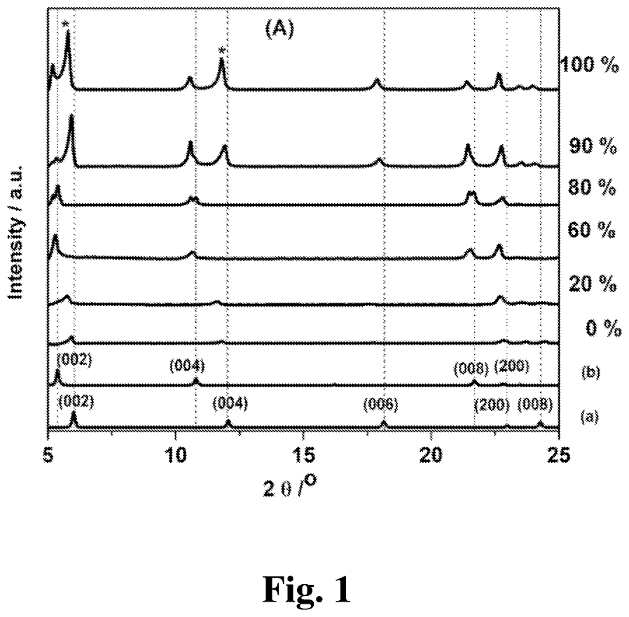

FIG. 2 shows an enlarged section of an XRD diagram of a layered niobate according to the present invention, where the 001 peaks of the double-structured layered niobate HSr₂Nb₃O₁₀*x H₂O can clearly be seen, and where the spacing between the layers is 15.3 Å or 16.9 Å;

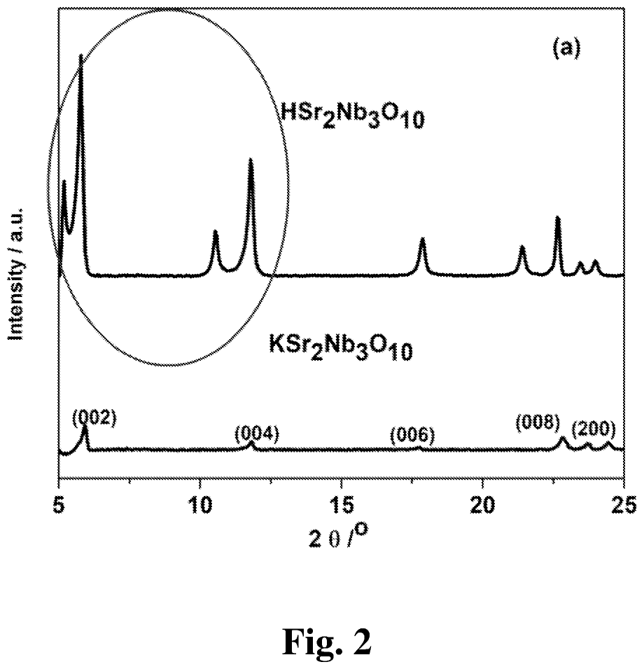

FIG. 3 shows the length of the c axis or the layer spacing in a layered niobate according to the present invention depending on the degree of exchange of K⁺ for H⁺;

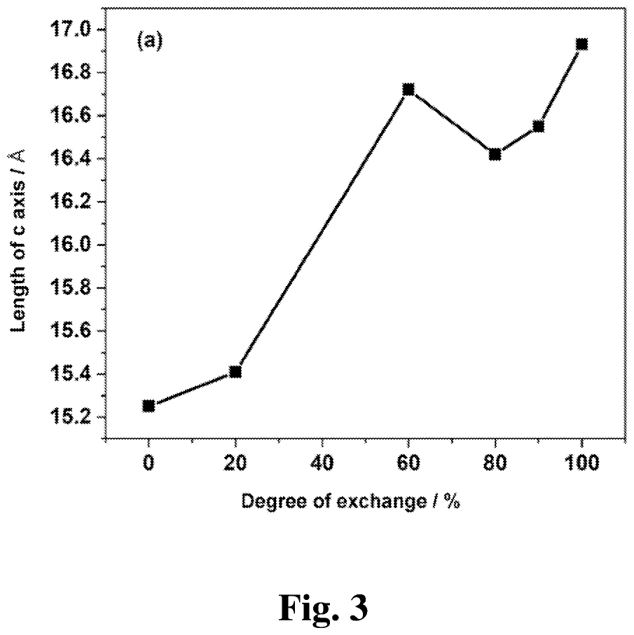

FIG. 4 shows the dependency of the hydrogen formation rate on the degree of exchange of K⁺ for H⁺ in a layered niobate according to the present invention; and

FIG. 5 shows a comparison of the XRD diagrams of the layered niobates in Table 1, which were used in the Examples, where the division of the layer spacings (“double peak”) can clearly be seen (Example 1 and Example 2).

### DETAILED DESCRIPTION

The present invention firstly provides a layered niobate of the formula [HₐA_{b}]⁺[Sr₂Nb₃O₁₀]⁻, where [Sr₂Nb₃O₁₀]⁻ forms the main layers and [HₐA_{b}]⁺ forms the interlayers, where H is a group consisting of the elements H⁺ and H₃O⁺ and A is an element of the group of K⁺, Cs⁺ and Rb⁺, where 0.6≤a≤1 and 0≤b≤0.4, where a+b=1, characterized in that the layered niobate has different spacings between the main layers.

The layered niobate according to the present invention can, for example, be one having the composition [HₐA_{b}]⁺[Sr₂Nb₃O₁₀]⁻ where 0.6<a≤1 and 0≤b≤0.4, where a+b=1, for example, 0.7<a≤1 and 0≤b≤0.3, for example, 0.8<a≤1 and 0≤b≤0.2, in each case where a+b=1.

The layered niobate according to the present invention can, for example, be one of the type of the layered perovskites of the Dion-Jacobson type M[Sr₂Nb₃O₁₀], where M is [HₐA_{b}], as defined above. The layered niobate according to the present invention is thus notable in that the positively charged elements M⁺ are intercalated between the negatively charged main layers [Sr₂Nb₃O₁₀]⁻. The spacings between the individual layers, which can be determined by XRD measurements, correlate with the size of the intercalated elements M⁺. In the case according to the present invention, it has surprisingly been found that different layer spacings are formed in the layered niobate, this being expressed in the XRD diagram by the doubling of the corresponding reflections (“double peak”). Without being bound to any particular theory, it is assumed that inhomogeneous incorporation of water and/or hydrated hydronium ions into the interlayers results in the layer spacing between some layers being larger than between others, i.e., the layered niobate according to the present invention has two phases. The phase with the larger layer spacing is assumed to be a hydrated phase, while the phase with the smaller layer spacing is interpreted as a phase without additional incorporation of water in the interlayers. It has surprisingly been found that the photocatalytic activity of the layered niobate according to the present invention increases significantly with the occurrence of the two phases, hydrated and dehydrated. The present invention therefore provides the layered niobate having, for example, a hydrated phase and a dehydrated phase. The hydrated phase here comprises water molecules and/or hydrated hydronium ions (H₃O⁺*H₂O) in the interlayers, while the dehydrated phase does not comprise any corresponding molecules in the interlayers.

It has previously been described that the photocatalytic activity of layered perovskites can be increased if at least some of the alkali metal ions usually intercalated in the interlayers are exchanged with protons. In an embodiment of the present invention, the layered niobate can, for example, have a degree of protonation of at least 60%, for example, more than 70%, for example, 80% to 100%. In the context of the present invention, “degree of protonation” refers to the proportion of alkali metal ions in the interlayers that has been replaced by protons. The degree of protonation can therefore be determined by determining the content of the replaced alkali metal ion, for example, via EDX. A degree of protonation of 60% is therefore to be understood to mean that 60% of the alkali metal ions usually intercalated in the interlayers have been replaced by protons. The degree of protonation can be measured by comparing the content of alkali metal ions to the unprotonated compound, as described above.

The layered niobate according to the present invention is particularly notable in that it has two phases with different layer spacings. These phases can be identified via XRD measurements. In an embodiment, the 002 and 004 x-ray diffraction reflections of the layered niobate according to the present invention appear as two reflections (“double peak”). In the XRD spectrum of the layered niobate according to the present invention, said reflections therefore appear as double reflections, instead of individual reflections as in the spectra of conventional layered niobates.

The photocatalytic activity of the layered niobates according to the present invention can be increased by replacing at least some of the alkali metal ions intercalated in the interlayers with protons. This exchange has proven to be particularly efficient if the alkali metal ions are potassium ions. In an embodiment of the present invention, A can, for example, be a potassium ion.

Without being bound to any particular theory, it is assumed that it is in particular the step of protonation that contributes to the formation of the special structure of the layered niobates according to the present invention. In an embodiment, the layered niobate can, for example, be produced by treating a compound of the formula ASr₂Nb₃O₁₀, where A is an element of the group of K⁺, Cs⁺ and Rb⁺, with aqueous nitric acid (HNO₃). The treatment with the aqueous nitric acid can, for example, be performed at a temperature of 40° C. to 70° C., for example, 50° C. to 65° C. The duration of the treatment is guided by the desired degree of protonation and, in an embodiment, may be 3 to 24 hours, for example, 5 to 20 hours, for example, 12 to 18 hours. It has also proven advantageous to renew the aqueous nitric acid during the treatment. In an embodiment, the aqueous nitric acid solution can, for example, be replaced by a fresh solution every 4 to 10 hours, for example, every 5 to 8 hours. In an embodiment, the concentration of the aqueous nitric acid solution can, for example, be 0.5 to 2.5 M, for example, 0.5 to 1.5 M.

The present invention further provides a process for producing the layered niobate according to the present invention, the process comprising the treatment of a compound of the general formula ASr₂Nb₃O₁₀, where A is an element of the group of elements K⁺, Cs⁺ and Rb⁺, with aqueous nitric acid (HNO₃) at a temperature of 40° C. to 70° C., for example, 50° C. to 65° C. The duration of the treatment is guided by the desired degree of protonation and can, for example, be 3 to 24 hours, for example, 5 to 20 hours, for example, 12 to 18 hours. It has also proven to be advantageous to renew the aqueous nitric acid during the treatment. In an embodiment, the aqueous nitric acid solution can, for example, be replaced by a fresh solution every 4 to 10 hours, for example, every 5 to 8 hours. In an embodiment, the concentration of the aqueous nitric acid solution can, for example, be 0.5 to 2.5 M, for example, 0.5 to 1.5 M.

The present invention further provides a layered niobate obtainable by treating a compound of the general formula ASr₂Nb₃O₁₀, where A is an element of the group of elements K⁺, Cs⁺ and Rb⁺, with aqueous nitric acid (HNO₃) at a temperature of 40° C. to 70° C., for example, 50° C. to 65° C. The layered niobate obtained in this way has a composition of the formula [HₐA_{b}]⁺[Sr₂Nb₃O₁₀]⁻, where [Sr₂Nb₃O₁₀]⁻ forms the main layers and [HₐA_{b}]⁺ forms the interlayers, where H is a group consisting of the elements H⁺ and H₃O⁺ and A is an element of the group of K⁺, Cs⁺ and Rb⁺, where 0.6≤a≤1 and 0≤b≤0.4, where a+b=1, and has different spacings between the main layers.

The compound of the general formula ASr₂Nb₃O₁₀, which is used as a starting compound in the production of the layered niobates according to the present invention can, for example, be produced via molten salt synthesis or solid phase synthesis.

The layered niobates according to the present invention feature high photocatalytic activity. The present invention therefore further provides for the use of the layered niobate according to the present invention as a photocatalyst, for example, as a photocatalyst in the photoinduced splitting of water.

The present invention further provides a photocatalyst comprising a layered niobate according to the present invention. It has surprisingly been found that the amount of hydrogen generated by the photocatalyst according to the present invention is higher than that achieved by conventional photocatalysts under the same conditions. The photocatalyst according to the present invention can, for example, further comprise a rhodium cocatalyst.

The present invention is illustrated in greater detail below on the basis of examples which should, however, in no way be considered as a limitation of the concept of the present invention.

### Examples

KSr₂Nb₃O₁₀ was produced by molten salt synthesis, as described, for example, by Kulischow et al. in Catal. Today 2017, 287, 65-69.

KSr₂Nb₃O₁₀ was stirred in 1M HNO₃ solution at 60° C. for various time intervals. The degree of protonation was monitored via energy-dispersive x-ray spectroscopy (EDX).

X-ray diffraction analyses were carried out via a PANalytical MPD diffractometer with Cu—Kₐ radiation (λ=0.1541 nm) in the 2Θ range from 5° to 30°.

EDX elemental analysis was carried out using a Philips LEO Gemini 928 field emission SEM at a 20 kV acceleration voltage.

The photocatalytic investigations were carried out as described in Kulischow et al. in Catal. Today 2017, 287, 65-69 in a double-walled quartz reactor. The reactor was cooled to 10° C. in order to rule out thermal influences. The light source used was a 350 W Hg lamp. For the detection of the hydrogen formed, use was made of a Shimadzu GC-2014 gas chromatograph, equipped with a detector for thermal conductivity (TCD) and a RESTEK ShinCarbon ST 100/120 column. The column was maintained at a temperature of 35° C. during the measurement and the elution time for H₂ was 1 minute.

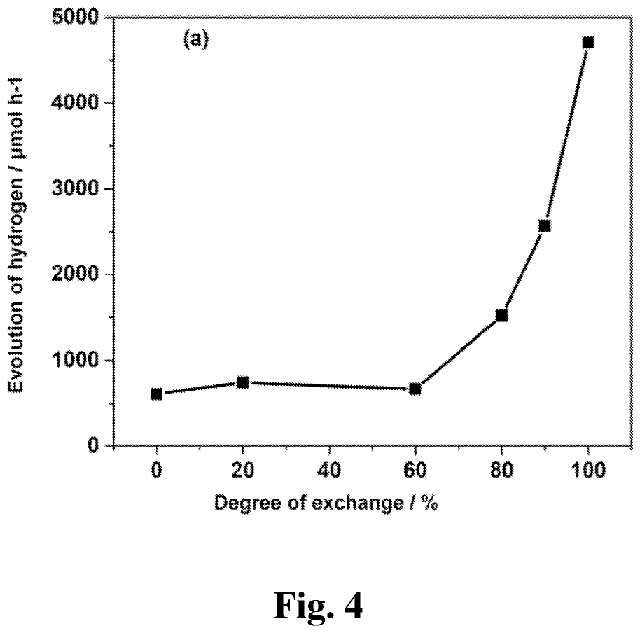

In a typical experiment, 0.3 g of the layered niobate according to the present invention with 0.3% by weight of Rh(NH₃)₅Cl)Cl₂ as cocatalyst was suspended in 600 ml of aqueous methanol solution (10% v/v) with ultrasound treatment and then irradiated with the 350 W Hg lamp. The starting pH of the solution was adjusted to 3 with perchloric acid. Prior to irradiation, the system was purged with argon in order to ensure that air was completely removed. The results of these photocatalytic measurements with the 350 W Hg lamp on the materials with different degrees of protonation are illustrated in FIG. 4.

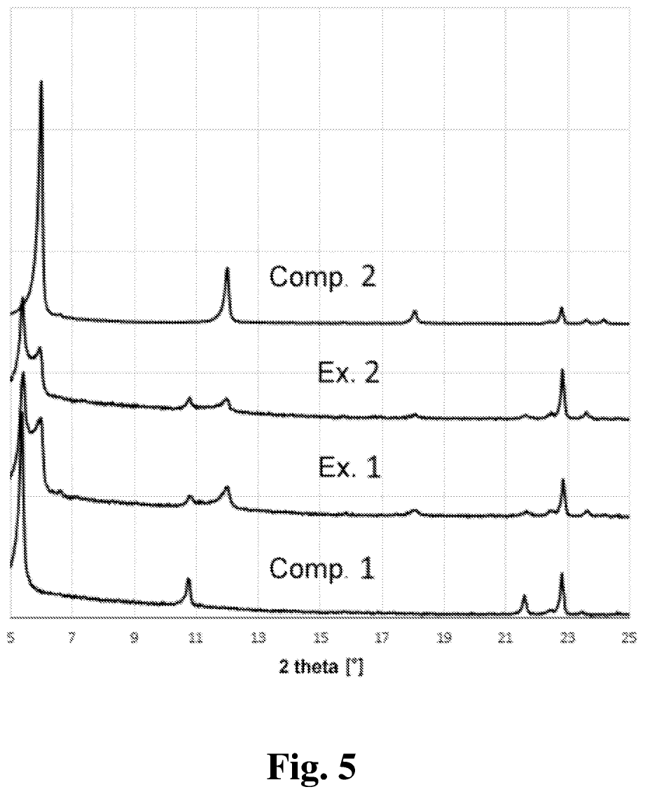

Further layered niobates were produced by varying the temperature and the duration of the acid treatment. The treatment with 1M HNO₃ was carried out at 20° C., 55° C., and 80° C. The duration of the treatments was adjusted so that a similar degree of protonation was achieved in all experiments at the end of the acid treatment, with the longest treatment (172 h) being necessary at 20° C. The chemical analysis of the layered niobates obtained is summarized in Table 1, with the starting compound KSr₂Nb₃O₁₀ being listed for comparison purposes. The samples used each had a degree of exchange or protonation of 83%, but only the samples of Examples 1 and 2, in the case of which the acid treatment was carried out at 55° C. and 60° C., respectively, showed the different layer spacings according to the present invention. The corresponding XRD diagrams are shown in FIG. 5. The acid treatments at 20° C. and 80° C. (Comparative Examples 1 and 2, respectively) each showed only one 002 and 004 peak in the XRD diagrams.

TABLE 1

| | | Analyses | | | Molar ratios based | | | |
|---|---|---|---|---|---|---|---|---|
| | | K | Sr | Nb | on Nb = 3 | | | |
| | Temperature | [% | [% | [% | H | | | |
| | [° C.] | by weight] | by weight] | by weight] | (1-K) | K | Sr | Nb |
| KSr₂Nb₃O₁₀ | — | 5.86 | 26.75 | 42.82 | — | 0.98 | 1.99 | 3 |
| Comparative | 20 | 1.06 | 27.84 | 44.35 | 0.83 | 0.17 | 2.00 | 3 |
| Example 1 | | | | | | | | |
| Example 1 | 55 | 1.05 | 27.83 | 44.26 | 0.83 | 0.17 | 2.00 | 3 |
| Example 2 | 60 | 1.05 | 27.81 | 44.14 | 0.83 | 0.17 | 2.00 | 3 |
| Comparative | 80 | 1.07 | 27.84 | 44.22 | 0.83 | 0.17 | 2.00 | 3 |
| Example 2 | | | | | | | | |

The aim of the photocatalyst development is the solar splitting of water. Hg lamps generate a high proportion of high-energy UV radiation, which increases the photocatalytic evolution of hydrogen but is not included in the solar spectrum. In order to test the application for the solar splitting of water, a quartz glass cuvette having the photocatalyst suspension of the layered niobates from Table 1 with Rh(NH₃)₅Cl)Cl₂ as cocatalyst as described above was irradiated with a xenon arc lamp (Perkin Elmer Cermax E300BF), instead of the Hg lamp, through a solar simulator filter. A water filter was used to avoid an increase in temperature. The illuminance was 1283.9 mW/cm 2 on the cuvette. The measured amount of hydrogen after 5 hours is summarized in Table 2:

TABLE 2

| | Comparatve | | | Comparative |
|---|---|---|---|---|
| Sample | Example 1 | Example 1 | Example 2 | Example 2 |
| H₂ [μmol/h] | 400 | 493 | 545 | 418 |

As can be seen from Table 2, the use of the layered niobates according to the present invention (Example 1 and Example 2) made it possible to achieve significantly higher hydrogen production.

The present invention is not limited to embodiments described herein; reference should be had to the appended claims.

What is claimed is:

1-15. (canceled)

16. A layered niobate having a formula [HₐA_{b}]⁺[Sr₂Nb₃O₁₀]⁻, wherein,
[Sr₂Nb₃O₁₀]⁻ forms main layers, and
[HₐA_{b}]⁺ forms interlayers,
wherein,
H comprises H⁺ and H₃O⁺,
A is an element of the group consisting of K⁺, Cs⁺ and Rb⁺,
0.6≤a≤1,
0≤b≤0.4, and
a+b=1, and
the layered niobate has different spacings between the main layers.

17. The layered niobate as recited in claim 16, wherein the layered niobate is a layered perovskite of a Dion-Jacobson type.

18. The layered niobate as recited in claim 16, wherein the layered niobate has a hydrated phase and a dehydrated phase.

19. The layered niobate as claimed as recited in claim 16, wherein,
the layered niobate has a degree of protonation of at least 60%, and
the degree of protonation is determined by via an energy-dispersive x-ray spectroscopy (EDX).

20. The layered niobate as recited in claim 16, wherein the layered niobate comprises at least one of water molecules and hydrated hydronium ions (H₃O⁺*H₂O) in the interlayers.

21. The layered niobate as recited in claim 16, wherein a 002 reflection and a 004 reflection each appear as a double peak in an XRD diagram of the layered niobate.

22. The layered niobate as recited in claim 16, wherein A is a potassium ion.

23. The layered niobate as recited in claim 16, wherein the layered niobate is produced by a method comprising:
treating a compound having a formula ASr₂Nb₃O₁₀ with an aqueous nitric acid (HNO₃),
where A is an element of the group consisting of K⁺, Cs⁺ and Rb⁺.

24. The layered niobate as recited in claim 23, wherein the treating with the aqueous nitric acid (HNO₃) is performed at a temperature of 40° C. to 70° C.

25. The layered niobate as recited in claim 23, wherein the aqueous nitric acid (HNO₃) has a concentration of 0.5 to 2.5 M.

26. A process for producing the layered niobate as recited in claim 16, the method comprising:
treating a compound having a general formula ASr₂Nb₃O₁₀ with an aqueous nitric acid (HNO₃) at a temperature of 40° C. to 70° C.,
where A is an element of the group consisting of K⁺, Cs⁺ and Rb⁺.

27. A layered niobate obtainable by the process as recited in claim 26.

28. A method of using the layered niobate as rectied in claim 16 as a photocatalyst, the method comprising:
providing the layered niobate; and
using the layered niobate as a photocatalyst.

29. The method of using as rectied in claim 28, wherein the photocatalyst provides for a photoinduced splitting of water.

30. A photocatalyst comprising the layered niobate as recited in claim 16.

31. The photocatalyst as recited in claim 30, wherein the photocatalyst further comprises a rhodium cocatalyst.
